(19) United States
(12) Patent Application Publication
(10) Pub. No.: US 2026/0369076 A1
(43) Pub. Date: Nov. 19, 2026

(54) METHOD OF UPDATING MAP, METHOD OF TRAINING MODEL, ELECTRONIC DEVICE, AND MEDIUM

(71) Applicant: Beijing Baidu Netcom Science Technology Co., Ltd., Beijing (CN)

(72) Inventors: Deguo XIA, Beijing (CN); Xiyan LIU, Beijing (CN); Jizhou HUANG, Beijing (CN)

(21) Appl. No.: 19/112,788

(22) PCT Filed: Jun. 17, 2024
(86) PCT No.: PCT/CN2024/099546

§ 371 Date: Mar. 18, 2025

(30) Foreign Application Priority Data
Dec. 6, 2023 (CN) 202311662055.4

(51) Int. Cl. G06V 20/56; G01C 21/00; G06T 7/73; G06V 10/26; G06V 10/764; G06V 10/766; G06V 10/776

(52) U.S. Cl. CPC G06V 20/588; G01C 21/3815; G01C 21/3859; G06T 7/73; G06V 10/26; G06V 10/764; G06V 10/776; G06T 2207/10016; G06T 2207/20081; G06T 2207/30256; G06V 10/766

(57) ABSTRACT

A method of updating a map, a method of training a model, an electronic device, and a medium, related to fields of artificial intelligence technology, autonomous driving, intelligent transportation, computer vision, and image processing. The method of updating a map includes: determining M collected image data based on a time sequence and historical map data, the historical map data and the M collected image data being associated with a same position information, M being an integer greater than or equal to 1; encoding the historical map data and the M collected image data to obtain a historical map feature and M collected image features, respectively; determining position information and category information of a target instance representing a lane information according to the historical map feature and the M collected image features; and updating data of the map according to the position information and category information of the target instance.

### CROSS REFERENCE TO RELATED APPLICATION(S)

This application is a Section 371 National Stage Application of International Application No. PCT/CN2024/099546, filed on Jun. 17, 2024, entitled “METHOD AND APPARATUS OF UPDATING MAP, METHOD AND APPARATUS OF TRAINING MODEL, ELECTRONIC DEVICE, AND MEDIUM”, and claims the benefit of priority to Chinese Patent Application No. 202311662055.4, filed on Dec. 6, 2023. The entire contents of this application are hereby incorporated herein by reference.

### TECHNICAL FIELD

The present disclosure relates to a field of artificial intelligence technology, and in particular to fields of autonomous driving, intelligent transportation, computer vision, image processing, and other fields. Specifically, the present disclosure provides a method of updating a map, a method of training a map update model, an electronic device, and a storage medium.

### BACKGROUND

Autonomous driving maps may provide rich road element data and lane-level path planning for autonomous vehicles, thus providing protection for autonomous driving. However, the coverage scale and update efficiency of autonomous driving maps have become crucial issues that constrain a development of this field.

### SUMMARY

The present disclosure provides a method of updating a map, a method of training a map update model, an electronic device, and a storage medium.

According to an aspect of the present disclosure, a method of updating a map is provided, including: determining historical map data and M collected image data, wherein the M collected image data are based on a time sequence, the historical map data and the M collected image data are associated with a same position information, M is an integer greater than or equal to 1; encoding the historical map data and the M collected image data to obtain a historical map feature and M collected image features, respectively; determining a position information of a target instance and a category information of the target instance according to the historical map feature and the M collected image features, where the target instance represents a lane information; and updating data of the map according to the position information of the target instance and the category information of the target instance.

According to another aspect of the present disclosure, a method of training a map update model is provided, including: determining a training sample, where the training sample includes a map prior, N sample images based on a time sequence, and a label, the map prior and the N sample images are associated with a same position information, the label indicates whether a real instance exists in the N sample images as well as a real position information of the real instance and a real category of the real instance, the real instance represents a lane information, and N is an integer greater than or equal to 1; encoding the map prior and the N sample images to obtain a map feature and N sample image features, respectively; determining an output position information of one or more output instances and an output category of the one or more output instances according to the map feature and the N sample image features; and training the map update model according to the real position information, the output position information, the real category, and the output category.

According to another aspect of the present disclosure, an electronic device is provided, including: at least one processor; and a memory communicatively connected to the at least one processor, where the memory stores instructions executable by the at least one processor, and the instructions, when executed by the at least one processor, are configured to cause the at least one processor to implement the methods provided in the present disclosure.

According to another aspect of the present disclosure, a non-transitory computer-readable storage medium having computer instructions therein is provided, where the computer instructions are configured to cause a computer to implement the methods provided in the present disclosure.

It should be understood that content described in this section is not intended to identify key or important features in embodiments of the present disclosure, nor is it intended to limit the scope of the present disclosure. Other features of the present disclosure will be easily understood through the following description.

### BRIEF DESCRIPTION OF THE DRAWINGS

The accompanying drawings are used for better understanding of the solution and do not constitute a limitation to the present disclosure. In the accompanying drawings:

FIG. 1 shows a schematic diagram of an application scenario of a method and an apparatus of training a map update model, and a method and an apparatus of updating a map according to embodiments of the present disclosure;

FIG. 2 shows a schematic flowchart of a method of training a map update model according to embodiments of the present disclosure;

FIG. 3A shows a schematic diagram of a representation of a lane line according to embodiments of the present disclosure;

FIG. 3B shows a schematic diagram of a representation of a lane group according to embodiments of the present disclosure;

FIG. 4 shows a schematic diagram of a method of training a map update model according to embodiments of the present disclosure;

FIG. 5 shows a schematic diagram of a method of updating a map according to embodiments of the present disclosure;

FIG. 6 shows a schematic flowchart of a method of updating a map according to embodiments of the present disclosure;

FIG. 7 shows a schematic structural diagram of an apparatus of training a map update model according to embodiments of the present disclosure;

FIG. 8 shows a schematic structural diagram of an apparatus of updating a map according to embodiments of the present disclosure; and

FIG. 9 shows a structural diagram of an electronic device used to implement the method of training a map update model and/or the method of updating a map in embodiments of the present disclosure.

### DETAILED DESCRIPTION OF EMBODIMENTS

Exemplary embodiments of the present disclosure will be described below with reference to accompanying drawings, which include various details of embodiments of the present disclosure to facilitate understanding and should be considered as just exemplary. Therefore, those ordinary skilled in the art should realize that various changes and modifications may be made to embodiments described herein without departing from the scope and spirit of the present disclosure. Likewise, for clarity and conciseness, descriptions of well-known functions and structures are omitted in the following description.

In some embodiments, a labor-intensive mode may be used to update a map. In such mode, the entire process is divided into links and elements, and the changed map elements are discovered and modified by trained operators.

Adopting the labor-intensive mode has high costs, low efficiency, and uncertainty in production quality due to a level of the operators.

In some other embodiments, a map may be updated based on a mode with general image recognition algorithm combined with manual interactive interpretation. There are roughly two solutions. In the first solution, a model directly provides modified results, which is usually based on a multi-stage generation mode combining image segmentation and post-processing. A segmentation model is used to obtain pixel positions of image elements such as lines and areas, and then vectorized line information and vectorized area information are extracted through post-processing strategies, which are then provided to the operators to assist in interactive map generation. In the second solution, a change detection model directly determines whether or not a point of interest has changed, and then the determination result is provided to the operators for assistance in modification.

Using the mode with general image recognition algorithm combined with manual interactive interpretation, the first solution is limited by multi-stage error accumulation and has funnel effect in automation capability. For example, after the segmentation model outputs a mask, a series of operations such as fitting, line extraction, and thinning are needed to extract lane lines, resulting in lower accuracy and recall of recognition results. In the second solution, the information provided by the change detection model is rough and insufficient to achieve a highly automated end-to-end mode for all elements.

The present disclosure aims to propose a method of training a map update model and a method of updating a map. In some embodiments, the method takes an existing map as prior and performs training based on image data collected by a camera. By constructing an end-to-end generation framework and training paradigm, the method achieves vectorized modeling and generation of map elements, thereby avoiding funnel effect. In addition, this method fully integrates existing maps and images, on the one hand, this may reconstruct maps with high fidelity, and on the other hand, it is possible to conveniently capture changes in map elements, achieving end-to-end map updates.

The technical solution provided in the present disclosure is illustrated in details in conjunction with the accompanying drawings and specific embodiments.

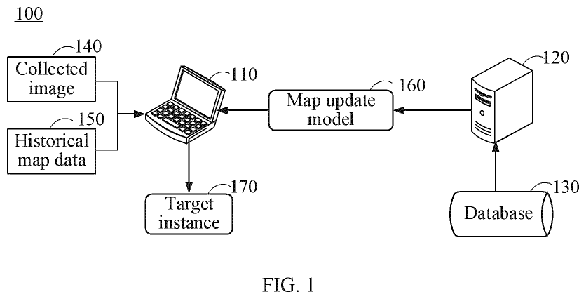

FIG. 1 shows a schematic diagram of an application scenario of a method and an apparatus of training a map update model, and a method and an apparatus of updating a map according to embodiments of the present disclosure.

As shown in FIG. 1, the application scenario 100 of these embodiments may include an electronic device 110, which may be any electronic device having processing functions, including but not limited to a smart phone, tablet computer, laptop computer, desktop computers, or server, etc.

The electronic device 110 may, for example, process an input collected image 140 and historical map data 150 to obtain a target instance 170, so that the historical map data 150 is updated using the target instance 170.

According to embodiments of the present disclosure, as shown in FIG. 1, the application scenario 100 may further include a server 120. The electronic device 110 may be communicatively connected with the server 120 through a network, which may include wireless or wired communication links.

For example, the server 120 may be used to train a map update model 160 and send the trained map update model 160 to the electronic device 110 in response to a model acquisition request sent by the electronic device 110, for performing map update work by the electronic device 110. In some embodiments, the electronic device 110 may also send the collected image 140 to the server 120 through a network, so that the server 120 updates the map according to the trained map update model 160.

According to embodiments of the present disclosure, as shown in FIG. 1, the application scenario 100 may further include a database 130, which may maintain a massive number of training samples, each training sample may include a sample image, a map prior, and a label. The server 120 may access the database 130 and extract some training samples from the database 130 to train the map update model 160.

When training the map update model 160, a loss function may be used to determine a loss of the map update model according to an output instance and a label, and the training of the model may be completed by minimizing the loss of the model.

It should be noted that the method of training a map update model provided in the present disclosure may be executed by the server 120, and the method of updating a map provided in the present disclosure may be executed by the electronic device 110 or the server 120. Correspondingly, the apparatus of training a map update model provided in the present disclosure may be provided in the server 120, and the apparatus of updating a map provided in the present disclosure may be provided in the electronic device 110 or the server 120.

It should be understood that the number and type of the electronic devices, servers and databases shown in FIG. 1 are just schematic. According to implementation needs, any number and any type of electronic devices, servers and databases may be provided.

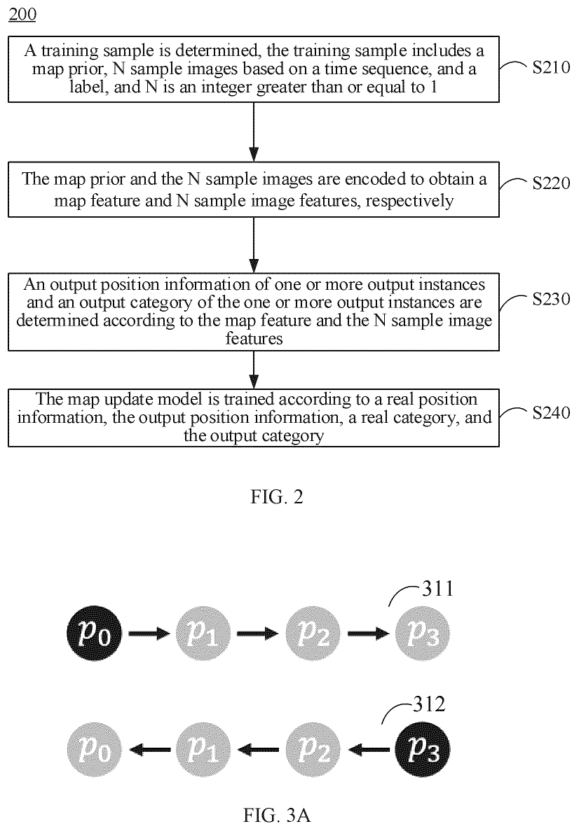

FIG. 2 shows a schematic flowchart of a method of training a map update model according to embodiments of the present disclosure.

As shown in FIG. 2, the method 200 of training a map update model may include operations S210 to S240.

In operation S210, a training sample is determined. The training sample includes a map prior, N sample images based on a time sequence, and a label, and N is an integer greater than or equal to 1.

In operation S220, the map prior and the N sample images are encoded to obtain a map feature and N sample image features, respectively.

In operation S230, an output position information of one or more output instances and an output category of the one or more output instances are determined according to the map feature and the N sample image features.

In operation S240, the map update model is trained according to a real position information, the output position information, a real category, and the output category.

For example, a plurality of training samples are pre-constructed, the training samples may be constructed based on manual annotation. Each training sample may include a map prior and at least one sample image. The map prior represents map information of a certain geographical region, and the at least one sample image is collected by a camera located in that geographical region. Therefore, the map prior and the N sample images are associated with the same position information. The sample image may include one or more real instances or include no real instance. The real instance represents a lane information. The lane information may include a line element and an area element, the line element may include a lane line, the lane line may include single solid line, double yellow lines, etc., and the area element may include a lane group, a zebra crossing, etc. For example, if a sample image includes 2 lane lines, then the sample image includes two real instances.

Each training sample may further include a label. The label indicates whether or not a real instance exists in the N sample images. If a real instance exists in a sample image, the label further indicates a real position information of the real instance and a real category of the real instance. A plurality of points may be used to represent the real instance, the real position information may include coordinates of the plurality of points, and the coordinates of each point correspond to a real sub-position information. The real category may include white single solid line, white dashed line, double yellow lines, etc.

For example, the map prior and N sample images are input into a map update model to be trained, and encoding, feature fusion, decoding, and other operations are performed through the map update model. Then, the map update model outputs a prediction result, and the prediction result may include the output position information of the output instance and the output category of the output instance. The output position information is similar to the real position information, which may include coordinates of one point or may include coordinates of a plurality of points. For the output category, the real category may be referred to.

Next, a total loss function value is calculated by using a predetermined loss function according to a difference between the real position information and the output position information and a difference between the real category and the output category. A network weight of the map update model may be adjusted through backpropagation algorithm to complete the training of the map update model. The predetermined loss function may include cross entropy loss function, etc., and the present disclosure is not limited to this.

Embodiments of the present disclosure trains a map update model based on sample images and a map prior, achieving end-to-end vectorized map element generation. The method changes the existing mode of automatic map update. On the one hand, the map prior is encoded and learned to ensure the fidelity of map reconstruction. On the other hand, by directly using serialized sample images as input, process steps may be reduced and update efficiency may be improved.

Before training the map update model, training samples are constructed in advance. In embodiments, manual work results are directly converted to a training data structure. Next, a detailed introduction to the process of automated construction of training samples is provided.

The following describes the method of obtaining sample images in the training samples. For example, sample images, position information, and device parameters may be acquired based on an automatic collection vehicle, i.e.,

$$D = {\{ {I}_{{bev}_{i}} , {Pos}_{i} , {Param}_{i} \}}_{i = 0}^{N - 1} ,$$

where N represents the total number of sample images based on a time sequence.

$${I}_{{bev}_{i}} = {\{ {I}_{i , j} \}}_{j = 0}^{K - 1}$$

represents an i^{th} sample image based on the time sequence. Posᵢ represents a position information of the camera when collecting the sample images. Paramᵢ represents a parameter of the camera used to collect the sample images. It should be noted that a single sample image may be a surround view image, which may include K images from different perspectives for the same position. For example, six images from different perspectives are obtained at a first moment, and the six images constitute a first sample image, and then six images from different perspectives are obtained at a second moment, and the six images constitute a second sample image. In some other embodiments, a single sample image may also include only one image from a single perspective. The method of obtaining sample images in the training samples is described above.

Then, based on the position information Posᵢ, map data associated with the position information Posᵢ may be extracted from a pre-built database. The map data in the database is a result (such as a lane line, a lane group, etc.) pre-marked by production operators. It should be noted that the map data obtained from the database includes both new and old versions of map data. The new version of map data is consistent with the sample image, while the old version of map data is inconsistent with the sample image. For example, if there are 4 lane lines in the sample image, the new version of map data also needs to include these 4 lane lines correspondingly, while the old version of map data may only include 3 lane lines. The training sample include sample images, a map prior, and a label. The sample images are acquired by the camera, the new version of map data is used to determine the label, and the old version of map data is used to determine the map prior in the training sample.

Next, a process of determining the label according to the new version of map data is illustrated.

For the new version of map data, the manual work result on lane lines may be extracted based on geometry information (such as respective coordinates of a plurality of points of a lane line), category information such as style information (such as straight, curve, white, yellow), etc. Through the above operations, multiple original vectorized point sets and style and color information corresponding to each original vectorized point set may be obtained. Each point set represents position information of an instance, and the style and color information corresponding to the point set is a category of the instance. Thus, original vectorized point sets

$${P}_{o r i} = {\{ {P}_{i} \}}_{i = 0}^{{N}_{ori} - 1}$$

and categories

$${L}_{o r i} = {\{ {L}_{i} \}}_{i = 0}^{{N}_{ori} - 1}$$

may be obtained, where Nₒᵣᵢ represents the number of real instances in a single sample image, Lᵢ∈ [symbol] ^{c} represents the real category of a single instance, and c is the total number of real categories.

After obtaining the original vectorized point sets

$${P}_{o r i} = {\{ {P}_{i} \}}_{i = 0}^{{N}_{ori} - 1} ,$$

fitting and interpolation may be performed on each point set Pᵢ∈Pₒᵣᵢ to obtain a point set Pᵢ=[p₀, p₁ . . . , p_{N}_{_{P}}₋₁] with a fixed number of points distributed uniformly, where Nₚ represents the number of points. If the number of instance pixel points is less than Nₚ, the actual number of pixel points may be taken. Considering the consistency of model modeling, in embodiments, the number of instances in a single sample image is fixed to Nᵢₙₛ, which is a preset value and may be greater than the number of instances in a conventional image. For example, the value of Nᵢₙₛ is set to 50. For an image with instances fewer than Nᵢₙₛ, the point set Pₒᵣᵢ may be completed by padding, where the padded part is represented as Ø. Thus, a point set expression

$${P}_{frame} = {\{ {P}_{i} \}}_{i = 0}^{{N}_{i n s} - 1}$$

of a single image and the corresponding category

$${L}_{frame} = {\{ {L}_{i} \}}_{i = 0}^{{N}_{i n s} - 1}$$

are obtained. The label of each instance includes the position information of the point set expression and the real category corresponding to the point set. Therefore, using the label (Ground True, GT) of each instance may be represented as Yᵢ=(Pᵢ, Lᵢ). It should be noted that, in the point set expression

$${P}_{frame} = {\{ {P}_{i} \}}_{i = 0}^{{N}_{i n s} - 1} ,$$

some point sets are obtained through padding, while some other point sets exist before the padding. The label needs to indicate whether or not the point set is obtained through padding, in order to accurately calculate the loss function value in the following operations.

The method of obtaining labels in the training samples is described above. Next, a process of determining the map prior according to the old version of map data is illustrated.

For the old version of map data, a method similar to the method of processing the new version of map data is used to obtain point sets and categories in the old version of map data. Next, the point sets in the old version of map data are visually represented and processed into modalities that are convenient for the map update model to receive. One processing method is to map the point set to mask M∈ [symbol] ^{H}^{_{gt}}^{×W}^{_{gt}}, that is, the point set is mapped to a mask with a background having a predetermined pixel value according to the category of the point set with a width h, the value range is 0,1 . . . , c. For example, 1 represents a single solid line, 2 represents double yellow lines, and H_{gt} and W_{gt} respectively represent a height of the map prior and a width of the map prior. The predetermined pixel value may be 0. For example, a sample image includes 3 lane lines, each lane line is a real instance, and each lane line corresponds to a category. Each lane line is represented by a point set including 50 points. For each real instance, the 50 points of the real instance are mapped to a mask with a black background, and the width h of each point is a preset value. This results in 3 lane lines on the mask with the black background, thus obtaining the map prior.

The method of obtaining sample images, map priors, and labels in the training samples are illustrated above. Next, a representation of lane information is illustrated.

In embodiments, the lane information includes a line element and an area element, the line element may include a lane line, and the area element may include a lane group. Each single lane information may be represented using a plurality of points.

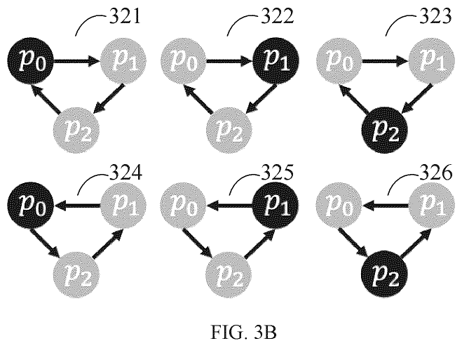

FIG. 3A shows a schematic diagram of a representation of a lane line according to embodiments of the present disclosure; FIG. 3B shows a schematic diagram of a representation of a lane group according to embodiments of the present disclosure. In the figures, points with black backgrounds represent starting points, and the arrows represent directions.

As shown in FIG. 3A, a point set corresponding to a lane line includes a plurality of linearly arranged points, and it is not needed to distinguish a direction of the lane line, so consistency of the starting and ending points does not need to be emphasized. The two equivalent arrangements 311 and 312 shown in FIG. 3A may both represent a lane line.

As shown in FIG. 3B, a point set corresponding to a lane group includes a plurality of points, and the arrangement order of the plurality of points does not affect the instance representation. Therefore, a lane group including k points may be characterized by 2×k equivalent arrangements. For example, as shown in FIG. 3B, three points are used to represent a lane group. There are a total of six representations 321 to 326 for the lane group, and any representation may be used to represent the lane group.

Next, a structure and a training algorithm of the map update model are described.

In embodiments, the map update model may include an image encoder E_{bev}, a map prior encoder Eₘₐₚ, a confidence-level map network, and a decoder. A plurality of task modules may be connected to an output end of the decoder, and a BEV encoder may be used as the image encoder.

A pre-constructed training sample is acquired, the training sample includes a map prior M∈ [symbol] ^{H}^{_{gt}}^{×W}^{_{gt}} and N sample images based on a time sequence

$${I}_{b e v} = {\{ {\{ {I}_{i , j} \}}_{j = 0}^{K - 1} \}}_{i = 0}^{N - 1} .$$

The map prior M∈ [symbol] ^{H}^{_{gt}}^{×W}^{_{gt}} is input into the map prior encoder Eₘₐₚ, and the map prior encoder Eₘₐₚ maps the map prior M∈ [symbol] ^{H}^{_{gt}}^{×W}^{_{gt}} to a feature space to obtain a map feature Fₘₐₚ. The sample images are input into the image encoder E_{bev}, and the image encoder E_{bev} maps the sample images to a feature space to obtain sample image features

$${F}_{b e v} = {\{ {F}_{i} \}}_{i}^{N - 1} .$$

Next, N second confidence-level maps respectively corresponding to the N sample image features are determined according to the N sample image features. For example, by inputting the N sample image features

$${F}_{b e v} = {\{ {F}_{i} \}}_{i}^{N - 1}$$

into the confidence-level map network, N second confidence-level maps

$$C {S}_{b e v} = {\{ C {S}_{i} \}}_{i}^{N - 1}$$

are obtained. The sample image features correspond one-to-one with the second confidence-level maps and have the same size. Each sample image feature includes a plurality of sub-features, each sub-feature may represent a pixel point in the sample image or a plurality of points in a region. Correspondingly, each second confidence-level map includes a plurality of confidence levels, and the plurality of confidence levels in each second confidence-level map represent weights of a plurality of sub-features in a corresponding sample image feature. For example, a first confidence level represents a weight of a first sub-feature.

Next, it is possible to determine the output position information of the one or more output instances and the output category of the one or more output instances according to the N sample image features, the N second confidence-level maps, and the map feature.

In some embodiments, a fusion processing may be performed on the N sample image features and the N second confidence-level maps to obtain a second intermediate fusion feature F_{sequence}. The fusion processing may include performing a dot product of each sample image feature and a corresponding second confidence-level map, and adding the dot product results frame by frame (one image by one image) to obtain the fused second intermediate fusion feature F_{sequence}. For example, sample images are collected at a plurality of moments, with each sample image corresponding to a sample image feature. The importance of each sub-feature in each sample image feature is learned through a confidence-level map network. For example, points near a lane line in the sample image are more important. If a point has high importance, the weight output by the confidence-level map network for that point is larger. Then, based on the confidence-level map network, the second confidence-level maps are output, and the plurality of sample image features are fused into the second intermediate fusion feature F_{sequence} based on the second confidence-level maps.

Then, a second target fusion feature Fₐₗₗ=Cat(F_{sequence}, Fₘₐₚ) may be determined according to the second intermediate fusion feature F_{sequence} and the map feature Fₘₐₚ. For example, the second intermediate fusion feature F_{sequence} and the map feature Fₘₐₚ may be concatenated along a channel dimension to obtain the second target fusion feature Fₐₗₗ=Cat(F_{sequence}, Fₘₐₚ). For example, the second intermediate fusion feature F_{sequence} has a size of C1*H*W, and the map feature Fₘₐₚ has a size of C2*H*W, and the concatenated second target fusion feature Fₐₗₗ=Cat(F_{sequence}, Fₘₐₚ) has a size of (C1+C2)*H*W. C represents the number of channels, H represents the height, and W represents the width.

Afterwards, the second target fusion feature Fₐₗₗ=Cat(F_{sequence}, Fₘₐₚ) may be decoded to obtain the output position information of the one or more output instances and the output category of the one or more output instances. For example, the second target fusion feature Fₐₗₗ=Cat(F_{sequence}, Fₘₐₚ) may be input into the decoder to obtain the output position information of each output instance and a confidence level of the output category of each output instance. The decoder may include a plurality of transformer layers. By learning instance-level contextual information and point-level contextual information and combining multi-task learning frameworks of semantic segmentation and instance segmentation, an output result

$${\hat{Y}}_{frame} = {\{ {\hat{Y}}_{i} \}}_{i = 0}^{{N}_{i n s} - 1}$$

may be obtained, Ŷᵢ=(\hat{P}ᵢ, \hat{L}ᵢ, Ŝᵢ), \hat{P}ᵢ represents the output position information of the output instance, Lᵢ represents a plurality of output categories, and Ŝᵢ represents the confidence level of each output category, and the output category with the greatest confidence level may be used as the output category determined by the model.

After obtaining the output position information, the output category, and the confidence level of the output category for each output instance, the total loss function value may be calculated based on the difference between the output position information and the real position information and the difference between the output category and the real category. The parameter of the map update model may be adjusted by minimizing the total loss function value.

Embodiments consider the consistency of multi-frame and multi-angle sample images, while learning point-level confidence-level maps, which may achieve adaptive fusion of a plurality of images to improve generation quality. In addition, improving the quality of visual features through temporal information may effectively alleviate issues such as occlusion and irregular truncation. By learning intuitive visual representations and artificially defined rule representations, the multi-stage process of dividing links and elements is avoided. End-to-end automation capability is improved for all elements and funnel effects may be addressed.

In addition, by fusing the plurality of sample images based on the second confidence-level maps, the sub-features with greater weights may have a greater impact on the second intermediate fusion feature, thereby improving the representation accuracy of the second target fusion feature and thus improving the training effect of the model.

It should be noted that in some other embodiments, the confidence-level map network may be omitted and the plurality of sample image features may be fused directly, such as fusing corresponding sub-features to obtain a fused feature, then fusing the fused feature with the map feature, and then inputting them together into the decoder.

It should be noted that in the training process, the output of the map update model includes a plurality of output instances, and the information output by the model may be matched with the label to obtain a matching relationship. Based on the matching relationship, the total loss function value may be accurately calculated to ensure an iteration effect of the model.

In an example, the matching relationship includes a first matching relationship. The first matching relationship represents a matching relationship between a real instance and an output instance, that is, indicating which real instance is matched with the output instance.

The first matching relationship may be determined by the following operations. One or more real instances is arranged to obtain a real instance sequence. One or more output instances is arranged and combined to obtain a plurality of candidate output instance sequences. For each candidate output instance sequence, a first difference evaluation value is determined for the candidate output instance sequence according to an output position information and an output category of each output instance in the candidate output instance sequence, a real position information and a real category of each real instance in the real instance sequence, an order of the real instance sequence, and an order of the candidate output instance sequence. In this way, the plurality of candidate output instance sequences correspond to a plurality of first difference evaluation value. Then, the first matching relationship is determined according to the minimum one of the first difference evaluation values.

For example, [symbol] represents a set of candidate output instance sequences, which includes a plurality of candidate output instance sequences. Each candidate output instance sequence includes a plurality of output instances arranged in order, and the order for arranging the instances varies in the plurality of candidate output instance sequences. An i^{th} real instance in the real instance sequence and an i output instance in the candidate output instance sequence form a pair of instances, and the first difference evaluation value is determined according to a sum of differences of the plurality of pairs of instances. The candidate instance matching sequence [symbol] corresponding to the minimum first difference evaluation value may be represented as:

$$\text{?} = arg \text{?} {\sum }_{i = 0}^{{N}_{i n s} - 1} {cost}_{i n s} ( \text{?} , {Y}_{i} ) ,$$

where costᵢₙₛ represents a matching loss term between instances, which includes at least one of a category loss function and a geometric loss function. The following equation takes costᵢₙₛ including the category loss function and the geometric loss function as an example:

$${cost}_{i n s} ( {\text{?}}_{( i )} , {Y}_{i} ) = {cost}_{c l s} ( {\text{?}}_{( i )} , {L}_{i} ) + {cost}_{g e o} ( {\text{?}}_{( i )} , {P}_{i} ) ,$$

where cost_{cis} represents the category loss function, and focus loss may be used as the category loss function; cost_{geo} represents the geometric loss function, which is used to measure a geometric correlation between the point set of the output instance and the point set of the real instance. Hungarian matching algorithm may be used as the geometric loss function, and embodiments do not limit the category loss function and geometric loss function.

In embodiments, the first matching relationship is determined, so that the total loss function value may be calculated based on the first matching relationship in the following operations, thereby improving the training effect of the model and ensuring the inference accuracy of the model.

In another example, the real position information of the same real instance includes a plurality of real sub-position information. Correspondingly, the output position information of the same output instance includes a plurality of output sub-position information. It may be understood that both the real instance and the output instance are represented by a plurality of points. Each real sub-position information may represent coordinates of a point in the real instance, and each output sub-position information may represent coordinates of a point in the output instance. The matching relationship includes a second matching relationship. The second matching relationship represents a matching relationship between a real sub-position information and an output sub-position information, that is, indicating which point in the real instance is matched with a point in the output instance.

The second matching relationship may be determined by the following operations. For the output instance and the real instance that meet the first matching relationship, the plurality of real sub-position information of the real instance are arranged to obtain a real point sequence. The plurality of output sub-position information of the output instance are arranged and combined to obtain a plurality of candidate point sequences. Then, a second difference evaluation value for each candidate point sequence is determined according to the plurality of real sub-position information, the plurality of output sub-position information, an order of the real point sequence, and an order of the candidate point sequence. In this way, the plurality of candidate point sequences correspond to the plurality of second difference evaluation values. Next, the second matching relationship is determined according to a minimum one of the second difference evaluation values.

For example, [symbol] represents a set of candidate point sequences, which includes a plurality of candidate point sequences. Each candidate point sequence includes a plurality of points in an output instance, and the order for arranging the points varies in the plurality of candidate point sequences. An i^{th} point in the real point sequence and an i^{th} point in the candidate point sequence form a pair of points. The second difference evaluation value is determined according to a sum of differences of the plurality of pairs of points. The candidate point sequence [symbol] corresponding to the minimum second difference evaluation value may be represented as:

$$\text{?} = arg \text{?} {\sum }_{j = 0}^{{N}_{p} - 1} {cost}_{point} ( {\hat{p}}_{j} , \text{?} ) ,$$

where costₚₒᵢₙₜ represents a matching loss term between a point in the output instance and a point in the real instance, that is, a matching loss between the output sub-position information and the real sub-position information. Manhattan distance may be used as the function of the matching loss, and embodiments do not limit the function of the matching loss.

In embodiments, the second matching relationship is determined, so that the total loss function value may be calculated based on the second matching relationship in the following operations, thereby improving the training effect of the model and ensuring the inference accuracy of the model.

The first matching relationship at the instance level and the second matching relationship at the level of the point in the instance are described above. In practical applications, the matching relationship include the first matching relationship and/or the second matching relationship. After obtaining the matching relationship, the total loss function value may be determined according to the matching relationship, the real position information, the output position information, the real category, and the output category. Then, the map update model may be trained according to the total loss function value.

It should be noted that in some other embodiments, other methods may also be used to determine the above matching relationship. For example, the first matching relationship may be determined based on relative positional relationships of various output instances and relative positional relationships of various real instances. Alternatively, according to the output position information of the output instance and the real position information of the real instance, the plurality of output instances may be numbered in a top to bottom and left to right manner, and the plurality of real instances may be numbered in a top to bottom and left to right manner, and it may be determined that the output instance and the real instance with the same number satisfy the first matching relationship.

The loss function used in the model training process is illustrated below.

In embodiments, a plurality of predetermined loss function values may be calculated, and then the total loss function value may be calculated based on the plurality of predetermined loss functions. The plurality of predetermined loss function values may include a point-level geometric loss function value, an instance-level geometric loss function value, a category loss function value, a binary classification loss function value, a semantic segmentation loss function value, and an instance segmentation loss function value. Each predetermined loss function is illustrated below.

For the point-level geometric loss function, the output sub-position information and the real sub-position information that meet the second matching relationship may form a pair of points, and the sum of distances of the pairs of points may be calculated to determine the point-level geometric loss function value.

For example, the point-level geometric loss function is as follows:

$${ℒ}_{p} = {\sum }_{i = 0}^{{N}_{i n s} - 1} {\sum }_{j = 0}^{{N}_{p} - 1} d i s t ( {\hat{p}}_{\text{?} , ( i ) , j} , {p}_{i , {\overline{𝓅}}_{i} ( j )} ) , {L}_{i} \neq ∅ ,$$

where dist represents a distance between points, and Manhattan distance may be used. Nᵢₙₛ and Nₚ represent the number of instances and the number of points within a single instance, respectively, and Lᵢ represents a category of an instance.

For the instance-level geometric loss function value, the instance-level geometric loss function value may be determined according to a difference between a first line segment and a second line segment in a pair of line segments. The first line segment has two output sub-position information as endpoints, and the second line segment has two real sub-position information as endpoints. In the same pair of line segments, the two endpoints of the first line segment and the two endpoints of the second line segment meet the second matching relationship.

For example, the instance-level geometric loss function is as follows:

$${ℒ}_{i n s} = - {\sum }_{i = 0}^{{N}_{i n s} - 1} {\sum }_{j = 0}^{{N}_{p} - 1} cosine ( {\text{?}}_{\text{?} ( i ) , j} , {link}_{i , {\overline{𝓅}}_{i} ( j )} ) , {L}_{i} \neq ∅ ,$$

where cosine represents a similarity, for example, cosine similarity is used; link represents a line segment formed by connecting two points, a line which connects adjacent two points may be used as the line segment. For example, the real instance includes 50 real sub-position information, then 49 line segments may be determined, and the output instance is similar, which will not be repeated here. Nᵢₙₛ and Nₚ represent the number of instances and the number of points within a single instance, respectively, and Lᵢ represents a category of an instance.

For the category loss function, the function value may be calculated in the following method. For the output instance and the real instance that meet the first matching relationship, a category loss function value is determined according to a difference between the output category of the output instance and the real category of the real instance.

For example, the category loss function is as follows:

$${ℒ}_{c l s} = {\sum }_{i = 0}^{{N}_{i n s} - 1} {ℒ}_{focal} ( {\hat{L}}_{\text{?} ( i )} , {L}_{i} ) ,$$

where [symbol] _{focal} represents a loss, for example, focus loss is used. \hat{L}ᵢ₍ₗ₎ and Lᵢ represent an output category and a real category, respectively. A category probability may be used as the confidence level, and a category with a confidence level above a threshold may be used as the output category. In addition, embodiments also introduce the positional relationship of instance geometry into category constraints for task-align, so the confidence level may represent both geometry and category.

In addition, due to the complex road conditions in natural scenes, such as ground wear, occlusion, and sudden changes in lighting, the map update model tends to output redundant element vector results with different categories. Therefore, in order to alleviate this situation from a model perspective, embodiments introduce a binary classification loss function as a constraint.

For the binary classification loss function, the function value may be calculated in the following method. For each output instance, a binary classification loss function value is determined according to whether a real instance that meets the first matching relationship with the output instance exists. That is, predicted instances that are not matched to any real instance are divided into an invalid category, and predicted instances that are matched to real instances are divided into a valid category. The valid category and the invalid category correspond to different binary classification loss function values.

For example, the binary classification loss function is as follows:

$${ℒ}_{f b} = {\sum }_{i = 0}^{{N}_{i n s} - 1} {ℒ}_{B C E} ( {\hat{L}}_{i} , {L}_{b c e ( i )} ) ;$$

$${L}_{b c e ( i )} = \{ \begin{matrix}0 , & {\hat{L}}_{i} ∈ ∅ \\ 1 , & {\hat{L}}_{i} ∉ ∅\end{matrix} ,$$

where [symbol] _{BCE} represents a binary cross entropy loss function; L_{bec(i)} represents a true value, which is 0 or 1, L_{bce(i)} of the output instance that has a matched real instance is 1, and L_{bce(i)} of the output instance that does not have a matched real instance is 0.

Embodiments further introduce a semantic segmentation task and an instance segmentation task, which achieve constraint at feature level by determining the segmentation mask of map elements, thereby improving model prediction accuracy and recall.

For the semantic segmentation loss function, the output position information of one or more output instances and the real position information of one or more real instances may be processed based on semantic segmentation, to obtain a first output mask and a first real mask, respectively; and a semantic segmentation loss function value is determined according to a difference between the first output mask and the first real mask.

For the instance segmentation loss function, the output position information of one or more output instances and the real position information of one or more real instances may be processed based on instance segmentation, to obtain a second output mask and a second real mask, respectively; and an instance segmentation loss function value is determined according to a difference between the second output mask and the second real mask.

For example, the semantic segmentation loss function and the instance segmentation loss function are as follows:

[symbol]

_{semantic_seg}= [symbol] _{bce}(\hat{M}ₛₑₘ,Mₛₑₘ)+ [symbol] _{dice}(\hat{M}ₛₑₘ,Mₛₑₘ);

[symbol]

_{instance_seg} [symbol] _{bce}(\hat{M}ᵢₙₛ,Mᵢₙₛ)+ [symbol] _{dice}(\hat{M}ᵢₙₛ,Mᵢₙₛ)

where \hat{M} and M represent an output mask and a real mask, respectively; the subscript sem represents semantic segmentation, the subscript ins represents instance segmentation, [symbol] _{bce} represents binary cross entropy loss, and [symbol] _{dice} represents dice loss.

After obtaining the point-level geometric loss function value, the instance-level geometric loss function value, the category loss function value, the binary classification loss function value, the semantic segmentation loss function value, and the instance segmentation loss function value, a weighted sum of the above predetermined loss function values may be calculated as the total loss function.

For example, the total loss function is as follows:

[symbol]

ₐₗₗ=λₚ [symbol] ₚ+λᵢₙₛ [symbol] ᵢₙₛ+λ_{cls} [symbol] _{cis}+λ_{fb} [symbol] _{fb}+λ_{seg}( [symbol] _{semantic}_{_{seg}}+ [symbol] _{instance_seg}),

where λ represents a weight coefficient.

In embodiments, the six predetermined loss functions described above are used to calculate the total loss function, thereby constraining the training of the map update model from multiple dimensions, so as to make the output results of the map update model more accurate and have stronger consistency.

It should be noted that 6 predetermined loss functions are described above. In practical applications, one to six predetermined loss functions may be arbitrarily selected from these 6 functions, and a weighted sum of the selected predetermined loss function values may be calculated as the total loss function value.

It should be noted that when calculating the six predetermined loss functions described above, functions such as Manhattan distance, cosine similarity, focus loss, binary cross entropy loss function, and dice function are used. In practical applications, these functions may be adjusted according to actual needs. Embodiments do not limit the functions used.

It should be noted that the difference between semantic segmentation and instance segmentation is that: for example, there are three lane lines, and the categories of the first lane line and the second lane line are the same, in semantic segmentation, the first lane line and the second lane line are in the same mask, while in instance segmentation, the first lane line and the second lane line are in two different masks.

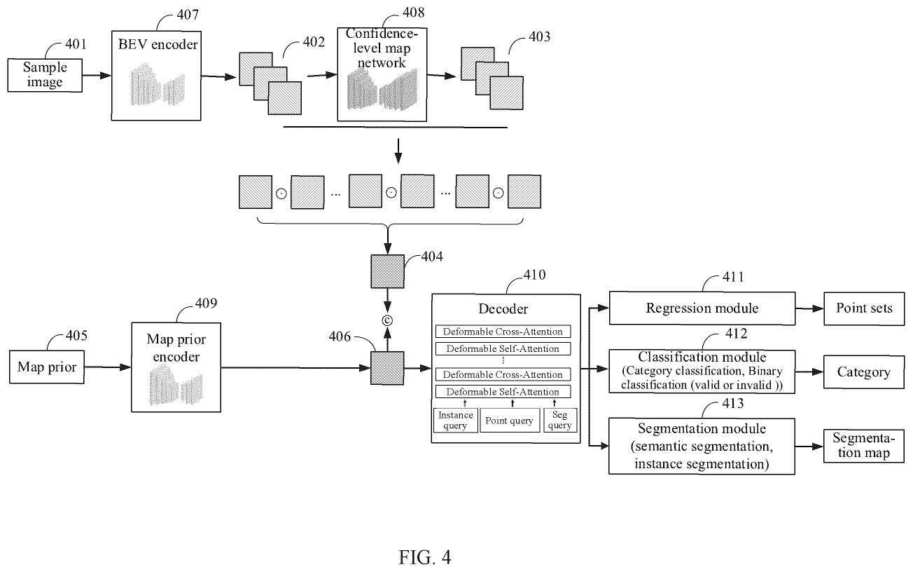

Next, combined with FIG. 4, the structure and training algorithm of the map update model are described.

FIG. 4 shows a schematic diagram of a method of training a map update model according to embodiments of the present disclosure.

As shown in FIG. 4, the map update model may include an image encoder 407, a map prior encoder 409, a confidence-level map network 408, and a decoder 410. A plurality of task modules, such as a regression module 411, a classification module 412, and a segmentation module 413, may be provided at the output end of the decoder 410. BEV encoder may be used as the image encoder 407.

A pre-constructed training sample is acquired. The training sample includes a map prior 405 and N sample images 401 based on a time sequence. The map prior 405 is input into the map prior encoder 409, and the map prior encoder 409 outputs a map feature 406. The N sample images 401 are input into the image encoder 407, and the image encoder 407 outputs N sample image features 402.

Next, the N sample image features 402 are input into the confidence-level map network 408 to obtain N second confidence-level maps 403. The sample image features 402 correspond one-to-one with the second confidence-level maps 403 and have the same size. Afterwards, a dot product may be performed on each sample image feature 402 and a corresponding second confidence-level map 403. After the dot product, the results are added frame by frame to obtain the fused second intermediate fusion feature 404.

Then, the second intermediate fusion feature 404 and the map feature 406 are concatenated along a channel dimension to obtain the second target fusion feature.

Afterwards, the second target fusion feature is input into the decoder 410 to obtain the output position information 407 of each output instance, the output category of each output instance, and a confidence level of the output category of each output instance.

The regression module 411 may determine the point set corresponding to each output instance based on the output position information 407, so as to calculate the point-level geometric loss function value and the instance-level geometric loss function value. The classification module 412 is used for category classification, so as to calculate the category loss function value. The classification module 412 is also used for binary classification into a valid category or an invalid category, so as to calculate the binary classification loss function value. The segmentation module 413 is used for semantic segmentation processing and instance segmentation processing, so as to calculate the semantic segmentation loss function value and the instance segmentation loss function value. By using the plurality of predetermined loss function values described above, the total loss function value may be calculated, and then the parameters of the map update model may be updated. For example, the parameters of the image encoder 407, the map prior encoder 409, the confidence-level map network 408, and the decoder 410 may be updated.

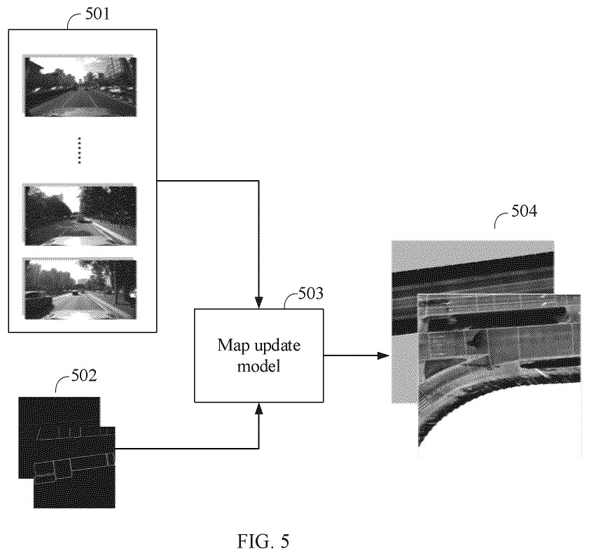

FIG. 5 shows a schematic diagram of a method of updating a map according to embodiments of the present disclosure.

As shown in FIG. 5, the method of updating a map includes the following operations. Historical map data 502 and M collected image data 501 are determined. The M collected image data 501 are based on a time sequence, and the historical map data 502 and the M collected image data 501 are associated with the same position information. M is an integer greater than or equal to 1. M may be the same as N, or M may be different from N. Then, the historical map data 502 and the M collected image data 501 are input into a trained map update model 503, to obtain a position information and a category of a target instance. Next, the historical map data is updated according to the position information of the target instance and the category of the target instance, to obtain an updated map data 504.

In embodiments, the map update model 503 may be trained using the training method described above. The data processing process of the map update model 503 may include: encoding the historical map data 502 and the M collected image data 501 to obtain a historical map feature and M collected image features, respectively; then, determining the position information of the target instance and the category information of the target instance according to the historical map feature and the M collected image features.

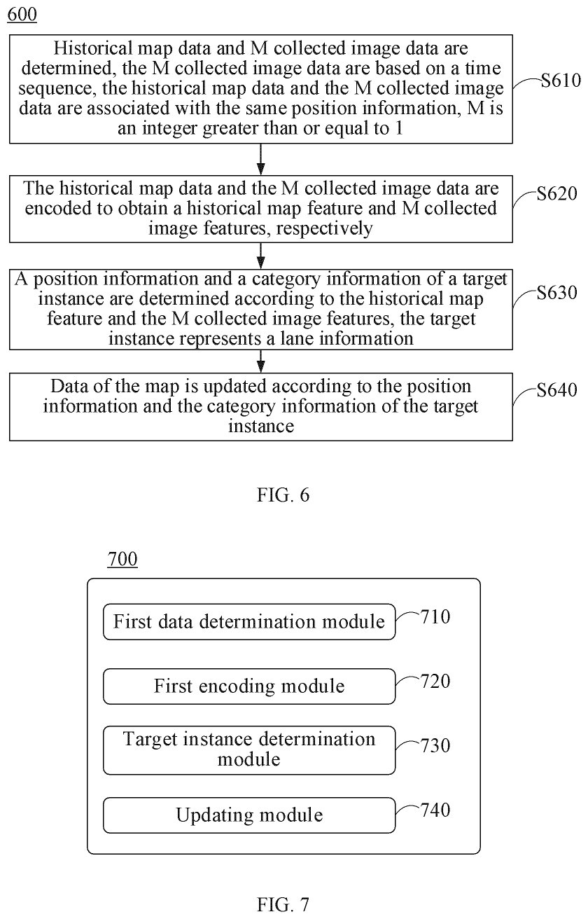

A detailed illustration of the method of updating a map is provided in conjunction with FIG. 6.

FIG. 6 shows a schematic flowchart of a method of updating a map according to embodiments of the present disclosure.

As shown in FIG. 6, the method 600 of updating a map may include operations S610 to S640.

In operation S610, historical map data and M collected image data are determined. The M collected image data are based on a time sequence, the historical map data and the M collected image data are associated with the same position information, M is an integer greater than or equal to 1.

In operation S620, the historical map data and the M collected image data are encoded to obtain a historical map feature and M collected image features, respectively.

In operation S630, a position information of a target instance and a category information of a target instance are determined according to the historical map feature and the M collected image features. The target instance represents a lane information.

In operation S640, the map data is updated according to the position information of the target instance and the category information of the target instance.

For example, the trained map update model includes an image encoder, a map prior encoder, and a decoder. The historical map data and the M collected image data may be input into the map prior encoder and the image encoder, respectively, so as to obtain the historical map feature and the M collected image features. Afterwards, fusion processing may be performed on the historical map feature and the M collected image features, and then the processing result may be input into the decoder to obtain the position information and the category information of the target instance.

It should be noted that the number of target instances may be one or more, and the position information of each target instance includes coordinates of a plurality of points. The category information may include single solid line, double yellow lines, etc. The position information may be mapped to the historical map data, and each point may be presented in a form indicated by the category of the target instance. It is also possible to fit a plurality of points as a line to achieve the effect of updating the map.

In embodiments of the present disclosure, existing historical map data is used as a prior, collected images are used as input, and an end-to-end geographic element generation is achieved by using a map update model. The element includes but is not limited to a line (lane line), an area (zebra crossing), a manually defined rule (lane group), and other elements. Using the existing historical map data as a prior may achieve high fidelity map reconstruction. By using the collected images as input to directly generate vectorized target results, the visual representation of complex geographic scenes may be fully learned, and a series of preprocessing and post-processing operations may be avoided, thereby improving the final recognition effect.

According to some other embodiments of the present disclosure, the map update model further includes a confidence-level map network. Correspondingly, the process of determining a position information and a category information of a target instance according to the historical map feature and the M collected image features may include the following operations. M first confidence-level maps respectively corresponding to the M collected image features are determined according to the M collected image features. For example, the M collected image features may be input into the confidence-level map network, and the confidence-level map network may output M first confidence-level maps. It should be noted that, similar to the training process, each collected image feature includes a plurality of sub-features, each first confidence-level map includes a plurality of confidence levels, and the plurality of confidence levels in each first confidence-level map represent weights of a plurality of sub-features in a corresponding collected image feature. Then, the position information and the category information of the target instance may be determined according to the M collected image features, the M first confidence-level maps, and the historical map feature.

In an example, fusion processing may be performed on the M collected image features and the M first confidence-level maps to obtain a first intermediate fusion feature. For example, a dot product of each image feature and a corresponding first confidence-level map may be performed, and the dot product results may be added frame by frame to obtain the fused first intermediate fusion feature. Next, a first target fusion feature may be determined according to the first intermediate fusion feature and the historical map feature. For example, the first intermediate fusion feature and the historical map feature may be concatenated along a channel dimension to obtain the first target fusion feature. Then, the first target fusion feature is decoded to obtain the position information and the category information of the target instance. For example, the first target fusion feature may be input into the decoder to obtain the output position information of each target instance and a confidence level of the output category of each target instance.

In embodiments, weights of the sub-features are determined through a confidence-level map network. By fusing the plurality of sample images based on the second confidence-level maps, the sub-features with greater weights may have a greater impact on the first intermediate fusion feature, thereby improving the representation accuracy of the first target fusion feature and thus improving the model training effect.

FIG. 7 shows a schematic structural diagram of an apparatus of updating a map according to embodiments of the present disclosure.

As shown in FIG. 7, the apparatus 700 of updating a map may include a first data determination module 710, a first encoding module 720, a target instance determination module 730, and an updating module 740.

The first data determination module 710 is used to determine historical map data and M collected image data, where the M collected image data are based on a time sequence, the historical map data and the M collected image data are associated with a same position information, M is an integer greater than or equal to 1.

The first encoding module 720 is used to encode the historical map data and the M collected image data to obtain a historical map feature and M collected image features, respectively.

The target instance determination module 730 is used to determine a position information of a target instance and a category information of the target instance according to the historical map feature and the M collected image features, where the target instance represents a lane information.

The updating module 740 is used to update data of the map according to the position information of the target instance and the category information of the target instance.

In embodiments, the target instance determination module includes a first determination sub-module and a second determination sub-module. The first determination sub-module is used to determine M first confidence-level maps respectively corresponding to the M collected image features according to the M collected image features, where each collected image feature includes a plurality of sub-features, each first confidence-level map includes a plurality of confidence levels, and the plurality of confidence levels in each first confidence-level map represent weights of the plurality of sub-features in a corresponding collected image feature. The second determination sub-module is used to determine the position information of the target instance and the category information of the target instance according to the M collected image features, the M first confidence-level maps, and the historical map feature.

In embodiments, the second determination sub-module includes a first fusion unit, a first determination unit, and a first decoding unit. The first fusion unit is used to perform fusion processing on the M collected image features and the M first confidence-level maps to obtain a first intermediate fusion feature. The first determination unit is used to determine a first target fusion feature according to the first intermediate fusion feature and the historical map feature. The first decoding unit is used to decode the first target fusion feature to obtain the position information and the category information of the target instance.

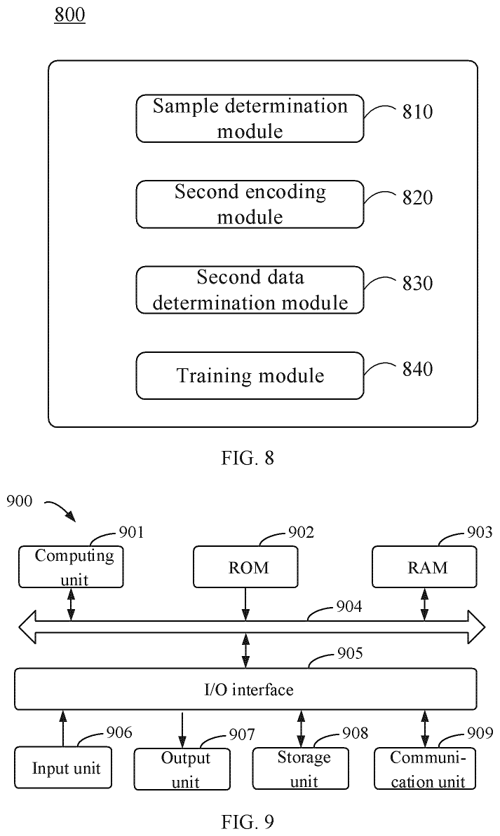

FIG. 8 is a schematic structural diagram of an apparatus of training a map update model according to embodiments of the present disclosure.

As shown in FIG. 8, the apparatus 800 of training a map update model may include a sample determination module 810, a second encoding module 820, a second data determination module 830, and a training module 840.

The sample determination module 810 is used to determine a training sample, where the training sample includes a map prior, N sample images based on a time sequence, and a label, the map prior and the N sample images are associated with a same position information, the label indicates whether a real instance exists in the N sample images as well as a real position information of the real instance and a real category of the real instance, the real instance represents a lane information, and N is an integer greater than or equal to 1.

The second encoding module 820 is used to encode the map prior and the N sample images to obtain a map feature and N sample image features, respectively.

The second data determination module 830 is used to determine an output position information of one or more output instances and an output category of the one or more output instances according to the map feature and the N sample image features.

The training module 840 is used to train the map update model according to the real position information, the output position information, the real category, and the output category.

In embodiments, the second data determination module includes a third determination sub-module and a fourth determination sub-module. The third determination sub-module is used to determine N second confidence-level maps respectively corresponding to the N sample image features according to the N sample image features, where each sample image feature includes a plurality of sub-features, each second confidence-level map includes a plurality of confidence levels, and the plurality of confidence levels in each second confidence-level map represent weights of the plurality of sub-features in a corresponding sample image feature. The fourth determination sub-module is used to determine the output position information of the one or more output instances and the output category of the one or more output instances according to the N sample image features, the N second confidence-level maps, and the map feature.

In embodiments, the fourth determination sub-module includes a second fusion unit, a second determination unit, and a second decoding unit. The second fusion unit is used to perform fusion processing on the N sample image features and the N second confidence-level maps to obtain a second intermediate fusion feature. The second determination unit is used to determine a second target fusion feature according to the second intermediate fusion feature and the map feature. The second decoding unit is used to decode the second target fusion feature to obtain the output position information and the output category of the one or more output instances.

In embodiments, the training module includes a matching sub-module, a total loss determination sub-module, and a training sub-module. The matching sub-module is used to determine a matching relationship, where the matching relationship includes a first matching relationship and/or a second matching relationship, the first matching relationship represents a matching relationship between a real instance and an output instance, the real position information of the same real instance includes a plurality of real sub-position information, the output position information of the same output instance includes a plurality of output sub-position information, and the second matching relationship represents a matching relationship between a real sub-position information and an output sub-position information. The total loss determination sub-module is used to determine a total loss function value according to the matching relationship, the real position information, the output position information, the real category, and the output category. The training sub-module is used to train the map update model according to the total loss function value.

In embodiments, the matching sub-module includes a first arranging unit, a second arranging unit, a first difference determination unit, a first relationship determination unit. The first arranging unit is used to arrange one or more real instances to obtain a real instance sequence. The second arranging unit is used to arrange and combine the one or more output instances to obtain a plurality of candidate output instance sequences. The first difference determination unit is used to determine, for each candidate output instance sequence, a first difference evaluation value for the candidate output instance sequence according to an output position information and an output category of each output instance in the candidate output instance sequence, a real position information and a real category of each real instance in the real instance sequence, an order of the real instance sequence, and an order of the candidate output instance sequence. The first relationship determination unit is used to determine the first matching relationship according to a minimum first difference evaluation value among a plurality of first difference evaluation values for the plurality of candidate output instance sequences.

In embodiments, the matching sub-module includes a second difference determination unit and a second relationship determination unit. The second difference determination unit is used to, for the output instance and the real instance that meet the first matching relationship, arrange the plurality of real sub-position information of the real instance to obtain a real point sequence; arrange and combine the plurality of output sub-position information of the output instance to obtain a plurality of candidate point sequences; determine a plurality of second difference evaluation values for the plurality of candidate point sequences according to the plurality of real sub-position information, the plurality of output sub-position information, an order of the real point sequence, and orders of the plurality of candidate point sequences. The second relationship determination unit is used to determine the second matching relationship according to a minimum second difference evaluation value among the plurality of second difference evaluation values.

In embodiments, the total loss determination sub-module includes: a total loss determination unit, used to determine the total loss function value according to a predetermined loss function value, where the predetermined loss function value is determined by at least one of: determining a point-level geometric loss function value according to a distance between the output sub-position information and the real sub-position information that meet the second matching relationship; determining an instance-level geometric loss function value according to a difference between a first line segment and a second line segment in a pair of line segments, where the first line segment has two output sub-position information as endpoints, and the second line segment has two real sub-position information as endpoints, and in the same pair of line segments, the two endpoints of the first line segment and the two endpoints of the second line segment meet the second matching relationship; for the output instance and the real instance that meet the first matching relationship, determining a category loss function value according to a difference between the output category of the output instance and the real category of the real instance; for each output instance, determining a binary classification loss function value according to whether a real instance that meets the first matching relationship with the output instance exists; processing the output position information of the one or more output instances and the real position information of one or more real instances based on semantic segmentation, to obtain a first output mask and a first real mask respectively, and determining a semantic segmentation loss function value according to a difference between the first output mask and the first real mask; or processing the output position information of the one or more output instances and the real position information of one or more real instances based on instance segmentation, to obtain a second output mask and a second real mask respectively, and determining an instance segmentation loss function value according to a difference between the second output mask and the second real mask.

According to embodiments of the present disclosure, an electronic device is further provided, including at least one processor; and a memory communicatively connected to the at least one processor, where the memory stores instructions executable by the at least one processor, and the instructions, when executed by the at least one processor, are used to cause the at least one processor to perform the above methods.

According to embodiments of the present disclosure, a non-transitory computer-readable storage medium having computer instructions therein is further provided, where the computer instructions are used to cause a computer to perform the above methods.

According to embodiments of the present disclosure, a computer program product including a computer program is further provided, where the computer program, when executed by a processor, is used to cause the processor to perform the above methods.

FIG. 9 shows a structural diagram of an electronic device used to implement the method of training a map update model and/or the method of updating a map in embodiments of the present disclosure. The electronic device is intended to represent various forms of digital computers, such as a laptop computer, a desktop computer, a workstation, a personal digital assistant, a server, a blade server, a mainframe computer, and other suitable computers. The electronic device may further represent various forms of mobile devices, such as a personal digital assistant, a cellular phone, a smart phone, a wearable device, and other similar computing devices. The components as illustrated herein, and connections, relationships, and functions thereof are merely examples, and are not intended to limit the implementation of the present disclosure described and/or required herein.

As shown in FIG. 9, the electronic device 900 includes a computing unit 901 which may perform various appropriate actions and processes according to a computer program stored in a read only memory (ROM) 902 or a computer program loaded from a storage unit 908 into a random access memory (RAM) 903. In the RAM 903, various programs and data necessary for an operation of the electronic device 900 may also be stored. The computing unit 901, the ROM 902 and the RAM 903 are connected to each other through a bus 904. An input/output (I/O) interface 905 is also connected to the bus 904.

A plurality of components in the electronic device 900 are connected to the I/O interface 905, including: an input unit 906, such as a keyboard, or a mouse; an output unit 907, such as displays or speakers of various types; a storage unit 908, such as a disk, or an optical disc; and a communication unit 909, such as a network card, a modem, or a wireless communication transceiver. The communication unit 909 allows the electronic device 900 to exchange information/data with other devices through a computer network such as Internet and/or various telecommunication networks.

The computing unit 901 may be various general-purpose and/or dedicated processing assemblies having processing and computing capabilities. Some examples of the computing unit 901 include, but are not limited to, a central processing unit (CPU), a graphics processing unit (GPU), various dedicated artificial intelligence (AI) computing chips, various computing units that run machine learning model algorithms, a digital signal processing processor (DSP), and any suitable processor, controller, microcontroller, etc. The computing unit 901 executes various methods and processes described above, such as the methods above. For example, in some embodiments, the methods may be implemented as a computer software program which is tangibly embodied in a machine-readable medium, such as the storage unit 908. In some embodiments, the computer program may be partially or entirely loaded and/or installed in the electronic device 900 via the ROM 902 and/or the communication unit 909. The computer program, when loaded in the RAM 903 and executed by the computing unit 901, may execute one or more steps in the methods described above. Alternatively, in other embodiments, the computing unit 901 may be used to perform the methods by any other suitable means (e.g., by means of firmware).

Various embodiments of the systems and technologies described herein may be implemented in a digital electronic circuit system, an integrated circuit system, a field programmable gate array (FPGA), an application specific integrated circuit (ASIC), an application specific standard product (ASSP), a system on chip (SOC), a complex programmable logic device (CPLD), a computer hardware, firmware, software, and/or combinations thereof. These various embodiments may be implemented by one or more computer programs executable and/or interpretable on a programmable system including at least one programmable processor. The programmable processor may be a dedicated or general-purpose programmable processor, which may receive data and instructions from a storage system, at least one input device and at least one output device, and may transmit the data and instructions to the storage system, the at least one input device, and the at least one output device.

Program codes for implementing the methods of the present disclosure may be written in one programming language or any combination of more programming languages. These program codes may be provided to a processor or controller of a general-purpose computer, a dedicated computer or other programmable data processing apparatus, such that the program codes, when executed by the processor or controller, cause the functions/operations specified in the flowcharts and/or block diagrams to be implemented. The program codes may be executed entirely on a machine, partially on a machine, partially on a machine and partially on a remote machine as a stand-alone software package or entirely on a remote machine or server.

In the context of the present disclosure, a machine-readable medium may be a tangible medium that may contain or store a program for use by or in connection with an instruction execution system, an apparatus or a device. The machine-readable medium may be a machine-readable signal medium or a machine-readable storage medium. The machine-readable medium may include, but is not limited to, an electronic, magnetic, optical, electromagnetic, infrared, or semiconductor system, apparatus or device, or any suitable combination of the above. More specific examples of the machine-readable storage medium may include an electrical connection based on one or more wires, a portable computer disk, a hard disk, a random access memory (RAM), a read only memory (ROM), an erasable programmable read only memory (EPROM or a flash memory), an optical fiber, a compact disk read only memory (CD-ROM), an optical storage device, a magnetic storage device, or any suitable combination of the above.

In order to provide interaction with the user, the systems and technologies described here may be implemented on a computer including a display device (for example, a CRT (cathode ray tube) or LCD (liquid crystal display) monitor) for displaying information to the user, and a keyboard and a pointing device (for example, a mouse or a trackball) through which the user may provide the input to the computer. Other types of devices may also be used to provide interaction with the user. For example, a feedback provided to the user may be any form of sensory feedback (for example, visual feedback, auditory feedback, or tactile feedback), and the input from the user may be received in any form (including acoustic input, speech input or tactile input).

The systems and technologies described herein may be implemented in a computing system including back-end components (for example, a data server), or a computing system including middleware components (for example, an application server), or a computing system including front-end components (for example, a user computer having a graphical user interface or web browser through which the user may interact with the implementation of the system and technology described herein), or a computing system including any combination of such back-end components, middleware components or front-end components. The components of the system may be connected to each other by digital data communication (for example, a communication network) in any form or through any medium. Examples of the communication network include a local area network (LAN), a wide area network (WAN), and the Internet.

The computer system may include a client and a server. The client and the server are generally far away from each other and usually interact through a communication network. A relationship between the client and the server is generated through computer programs running on the corresponding computers and having a client-server relationship with each other.

It should be understood that steps of the processes illustrated above may be reordered, added or deleted in various manners. For example, the steps described in the present disclosure may be performed in parallel, sequentially, or in a different order, as long as a desired result of the technical solution of the present disclosure may be achieved. This is not limited in the present disclosure.

In the technical solution of the present disclosure, the collection, storage, use, processing, transmission, provision, and disclosure of the user's personal information involved are all in compliance with relevant laws and regulations and do not violate public order and good customs.

In the technical solution of the present disclosure, authorization or consent is obtained from the user before the user's personal information is obtained or collected.

The above-mentioned specific embodiments do not constitute a limitation on the scope of protection of the present disclosure. Those skilled in the art should understand that various modifications, combinations, sub-combinations and substitutions may be made according to design requirements and other factors. Any modifications, equivalent replacements and improvements made within the spirit and principles of the present disclosure shall be contained in the scope of protection of the present disclosure.

1: A method of updating a map, comprising:
determining historical map data and M collected image data, wherein the M collected image data are based on a time sequence, the historical map data and the M collected image data are associated with a same position information, M is an integer greater than or equal to 1;
encoding the historical map data and the M collected image data to obtain a historical map feature and M collected image features, respectively;
determining a position information of a target instance and a category information of the target instance according to the historical map feature and the M collected image features, wherein the target instance represents a lane information; and
updating data of the map according to the position information of the target instance and the category information of the target instance.

2: The method according to claim 1, wherein the determining a position information of a target instance and a category information of the target instance according to the historical map feature and the M collected image features comprises:
determining M first confidence-level maps respectively corresponding to the M collected image features according to the M collected image features, wherein each of the M collected image features comprises a plurality of sub-features, each of the M first confidence-level maps comprises a plurality of confidence levels, and the plurality of confidence levels in each of the M first confidence-level maps represent weights of the plurality of sub-features in a corresponding collected image feature; and
determining the position information of the target instance and the category information of the target instance according to the M collected image features, the M first confidence-level maps, and the historical map feature.

3: The method according to claim 2, wherein the determining the position information of the target instance and the category information of the target instance according to the M collected image features, the M first confidence-level maps, and the historical map feature comprises:
performing fusion processing on the M collected image features and the M first confidence-level maps to obtain a first intermediate fusion feature;
determining a first target fusion feature according to the first intermediate fusion feature and the historical map feature; and
decoding the first target fusion feature to obtain the position information of the target instance and the category information of the target instance.

4: A method of training a map update model, comprising:
determining a training sample, wherein the training sample comprises a map prior, N sample images based on a time sequence, and a label, the map prior and the N sample images are associated with a same position information, the label indicates whether a real instance exists in the N sample images as well as a real position information of the real instance and a real category of the real instance, the real instance represents a lane information, and N is an integer greater than or equal to 1;
encoding the map prior and the N sample images to obtain a map feature and N sample image features, respectively;
determining an output position information of one or more output instances and an output category of the one or more output instances according to the map feature and the N sample image features; and
training the map update model according to the real position information, the output position information, the real category, and the output category.

5: The method according to claim 4, wherein the determining an output position information of one or more output instances and an output category of the one or more output instances according to the map feature and the N sample image features comprises:
determining N second confidence-level maps respectively corresponding to the N sample image features according to the N sample image features, wherein each of the N sample image features comprises a plurality of sub-features, each of the N second confidence-level maps comprises a plurality of confidence levels, and the plurality of confidence levels in each of the N second confidence-level maps represent weights of the plurality of sub-features in a corresponding sample image feature; and
determining the output position information of the one or more output instances and the output category of the one or more output instances according to the N sample image features, the N second confidence-level maps, and the map feature.

6: The method according to claim 5, wherein the determining the output position information of the one or more output instances and the output category of the one or more output instances according to the N sample image features, the N second confidence-level maps, and the map feature comprises:
performing fusion processing on the N sample image features and the N second confidence-level maps to obtain a second intermediate fusion feature;
determining a second target fusion feature according to the second intermediate fusion feature and the map feature; and
decoding the second target fusion feature to obtain the output position information of the one or more output instances and the output category of the one or more output instances.

7: The method according to claim 4, wherein the training the map update model according to the real position information, the output position information, the real category, and the output category comprises:
determining a matching relationship, wherein the matching relationship comprises a first matching relationship and/or a second matching relationship, the first matching relationship represents a matching relationship between a real instance and an output instance, the real position information of the same real instance comprises a plurality of real sub-position information, the output position information of the same output instance comprises a plurality of output sub-position information, and the second matching relationship represents a matching relationship between a real sub-position information and an output sub-position information;
determining a total loss function value according to the matching relationship, the real position information, the output position information, the real category, and the output category; and
training the map update model according to the total loss function value.

8: The method according to claim 7, wherein the determining a matching relationship comprises:
arranging one or more real instances to obtain a real instance sequence;
arranging and combining the one or more output instances to obtain a plurality of candidate output instance sequences;
determining, for each of the plurality of candidate output instance sequences, a first difference evaluation value for the cu candidate output instance sequence according to an output position information and an output category of each output instance in the candidate output instance sequence, a real position information and a real category of each real instance in the real instance sequence, an order of the real instance sequence, and an order of the candidate output instance sequence; and
determining the first matching relationship according to a minimum first difference evaluation value among a plurality of first difference evaluation values for the plurality of candidate output instance sequences.

9: The method according to claim 7, wherein the determining a matching relationship comprises: for the output instance and the real instance that meet the first matching relationship,
arranging the plurality of real sub-position information of the real instance to obtain a real point sequence;
arranging and combining the plurality of output sub-position information of the output instance to obtain a plurality of candidate point sequences;
determining a plurality of second difference evaluation values for the plurality of candidate point sequences according to the plurality of real sub-position information, the plurality of output sub-position information, an order of the real point sequence, and orders of the plurality of candidate point sequences; and
determining the second matching relationship according to a minimum second difference evaluation value among the plurality of second difference evaluation values.

10: The method according to claim 7, wherein the determining a total loss function value according to the matching relationship, the real position information, the output position information, the real category, and the output category comprises:
determining the total loss function value according to a predetermined loss function value,
wherein the predetermined loss function value is determined by at least one of:
determining a point-level geometric loss function value according to a distance between the output sub-position information and the real sub-position information that meet the second matching relationship;
determining an instance-level geometric loss function value according to a difference between a first line segment and a second line segment in a pair of line segments, wherein the first line segment has two output sub-position information as endpoints, and the second line segment has two real sub-position information as endpoints, and in a same pair of line segments, the two endpoints of the first line segment and the two endpoints of the second line segment meet the second matching relationship;
determining, for the output instance and the real instance that meet the first matching relationship, a category loss function value according to a difference between the output category of the output instance and the real category of the real instance;
determining, for each output instance, a binary classification loss function value according to whether or not a real instance that meets the first matching relationship with the output instance exists;
processing the output position information of the one or more output instances and the real position information of one or more real instances based on semantic segmentation, to obtain a first output mask and a first real mask, respectively; and determining a semantic segmentation loss function value according to a difference between the first output mask and the first real mask; or
processing the output position information of the one or more output instances and the real position information of one or more real instances based on instance segmentation, to obtain a second output mask and a second real mask, respectively; and determining an instance segmentation loss function value according to a difference between the second output mask and the second real mask.

11-20. (canceled)

21: An electronic device, comprising:
at least one processor; and
a memory communicatively connected to the at least one processor, wherein the memory stores instructions executable by the at least one processor, and the instructions, when executed by the at least one processor, are configured to cause the at least one processor to at least:
determine historical map data and M collected image data, wherein the M collected image data are based on a time sequence, the historical map data and the M collected image data are associated with a same position information, M is an integer greater than or equal to 1;
encode the historical map data and the M collected image data to obtain a historical map feature and M collected image features, respectively;
determine a position information of a target instance and a category information of the target instance according to the historical map feature and the M collected image features, wherein the target instance represents a lane information; and
update data of the map according to the position information of the target instance and the category information of the target instance.

22: A non-transitory computer-readable storage medium having computer instructions therein, wherein the computer instructions are configured to cause a computer to implement the method according to claim 1.

23. (canceled)

24: A non-transitory computer-readable storage medium having computer instructions therein, wherein the computer instructions are configured to cause a computer to implement the method according to claim 4.

25: The electronic device according to claim 21, wherein the instructions are further configured to cause the at least one processor to at least:
determine M first confidence-level maps respectively corresponding to the M collected image features according to the M collected image features, wherein each of the M collected image features comprises a plurality of sub-features, each of the M first confidence-level maps comprises a plurality of confidence levels, and the plurality of confidence levels in each of the M first confidence-level maps represent weights of the plurality of sub-features in a corresponding collected image feature; and
determine the position information of the target instance and the category information of the target instance according to the M collected image features, the M first confidence-level maps, and the historical map feature.

26: The electronic device according to claim 25, wherein the instructions are further configured to cause the at least one processor to at least:
perform fusion processing on the M collected image features and the M first confidence-level maps to obtain a first intermediate fusion feature;
determine a first target fusion feature according to the first intermediate fusion feature and the historical map feature; and
decode the first target fusion feature to obtain the position information of the target instance and the category information of the target instance.

27: An electronic device, comprising:
at least one processor; and
a memory communicatively connected to the at least one processor, wherein the memory stores instructions executable by the at least one processor, and the instructions, when executed by the at least one processor, are configured to cause the at least one processor to implement the method according to claim 4.

28: The electronic device according to claim 27, wherein the instructions are further configured to cause the at least one processor to at least:
determine N second confidence-level maps respectively corresponding to the N sample image features according to the N sample image features, wherein each of the N sample image features comprises a plurality of sub-features, each of the N second confidence-level maps comprises a plurality of confidence levels, and the plurality of confidence levels in each of the N second confidence-level maps represent weights of the plurality of sub-features in a corresponding sample image feature; and
determine the output position information of the one or more output instances and the output category of the one or more output instances according to the N sample image features, the N second confidence-level maps, and the map feature.

29: The electronic device according to claim 28, wherein the instructions are further configured to cause the at least one processor to at least:
perform fusion processing on the N sample image features and the N second confidence-level maps to obtain a second intermediate fusion feature;
determine a second target fusion feature according to the second intermediate fusion feature and the map feature; and
decode the second target fusion feature to obtain the output position information of the one or more output instances and the output category of the one or more output instances.

30: The electronic device according to claim 27, wherein the instructions are further configured to cause the at least one processor to at least:
determine a matching relationship, wherein the matching relationship comprises a first matching relationship and/or a second matching relationship, the first matching relationship represents a matching relationship between a real instance and an output instance, the real position information of the same real instance comprises a plurality of real sub-position information, the output position information of the same output instance comprises a plurality of output sub-position information, and the second matching relationship represents a matching relationship between a real sub-position information and an output sub-position information;
determine a total loss function value according to the matching relationship, the real position information, the output position information, the real category, and the output category; and
train the map update model according to the total loss function value.

31: The electronic device according to claim 30, wherein the instructions are further configured to cause the at least one processor to at least:
arrange one or more real instances to obtain a real instance sequence;
arrange and combine the one or more output instances to obtain a plurality of candidate output instance sequences;
determine, for each of the plurality of candidate output instance sequences, a first difference evaluation value for the candidate output instance sequence according to an output position information and an output category of each output instance in the candidate output instance sequence, a real position information and a real category of each real instance in the real instance sequence, an order of the real instance sequence, and an order of the candidate output instance sequence; and
determine the first matching relationship according to a minimum first difference evaluation value among a plurality of first difference evaluation values for the plurality of candidate output instance sequences.
